(19) United States
(12) Patent Application Publication
(10) Pub. No.: US 2018/0214875 A1
(43) Pub. Date: Aug. 2, 2018

(54) CHEMICAL REAGENT BOTTLE INTERNALLY COATED WITH A FLUOROPOLYMER

(71) Applicant: Tedia Company, Inc., Fairfield, OH (US)

(72) Inventors: Jacob D. Miles, Cincinnati, OH (US); Lee D. Dapp, Cincinnati, OH (US); Gregory T. Huber, Hamilton, OH (US)

(21) Appl. No.: 15/881,066

(22) Filed: Jan. 26, 2018

Related U.S. Application Data
(60) Provisional application No. 62/451,365, filed on Jan. 27, 2017.

(51) Int. Cl. B01L 3/00; B65D 23/02

(52) U.S. Cl. CPC B01L 3/52; B65D 23/02; B01L 2300/16; B01L 2300/12; B01L 2200/16

(57) ABSTRACT

Provided herein is a chemical reagent bottle. The chemical reagent bottle includes a main body, a neck, and a fluoropolymer coating. The main body has a first interior surface defining a cavity for housing a chemical substance. The cavity has a preselected volume. The neck extends from the main body and has a second interior surface defining a hollow opening that is in fluid communication with the cavity. The fluoropolymer coating internally coats the first interior surface and the second interior surface with a fluoropolymer layer.

### CROSS-REFERENCE TO RELATED APPLICATIONS

This application claims the benefit of the filing date of U.S. Provisional Application No. 62/451,365, which was filed on Jan. 27, 2017. The contents of U.S. Provisional Application No. 62/451,365 are incorporated by reference in their entirety as part of this application.

### TECHNICAL FIELD

The present application relates to chemical reagent bottles, more particularly, glass chemical reagent bottles fully, seamlessly lined internally with a fluoropolymer.

### BACKGROUND

Fluoropolymers, namely polytetrafluoroethylene (PTFE), are the industrial standard materials of construction for wetted surfaces utilized in the industrial, large scale chemical and solvents industries in order to prevent contamination of product with particular attention to trace amounts of metal in particular. The vessels in such large scale process are typically metal tanks that are large enough for a person to spray coat the interior thereof. This is due to the characteristics of fluoropolymers including: chemical resistance, high thermal stability, lack of particle contribution, and low absorption of UV and visible light.

Currently, fluoropolymers are molded into bottles and sold at less economical prices due to the delicate and expensive nature of the material, the subsequent production difficulties associated with the handling of the polymers, and the toxic fumes created when handling fluoropolymers in an aqueous form. These bottles are used in conjunction with high purity products when the product is corrosive and/or demands no contamination or contributions of contamination from the glass bottle.

Polypropylene, and similar polymers, are widely used as one cheaper alternative to fluoropolymers, but do not have the same chemical or solvent resistance. These polymers are also likely to contribute particles and impurities, that can be extracted from the polypropylene such as plasticizers, monomers, and stabilizers, to the contained chemical or solvent. While being much more economical, polypropylene and similar materials are not capable of offering the same benefits as fluoropolymers.

Many types of glass (fluorinated, borosilicate, amber, etc.) are used as another cheaper alternative, but are prone to leach contaminants including trace metal ions and particles into the contained chemical or solvent. Types of glass can be treated in different ways, including fluorination, to increase the chemical and solvent resistance, but it still does not offer the same benefits as fluoropolymers.

External fluoropolymer coating is relatively common in several industries including the medical, pharmaceutical, food, and utility industries. This is targeted to provide a multitude of properties such as, but not limited to: non-stick, shatter-resistance, UV resistance, preservation, and chemical resistance.

There is a need for cheaper small scale (e.g., about 4 L to about 50 ml) chemical reagent or solvent bottles, such as glass bottles, internally coated with a fluoropolymer to provide the benefits of fluoropolymers noted above. Glass bottles of this size are typically suitable for the user to lift, move, pour, etc. However, the shape of such glass bottles, in particular, the narrow neck, makes coating the interior surface thereof difficult.

### SUMMARY

Provided herein is a chemical reagent bottle. The chemical reagent bottle includes a main body, a neck, and a fluoropolymer coating. The main body has a first interior surface defining a cavity for housing a chemical substance (e.g. a chemical reagent such as a solvent or an acid). The cavity has a preselected volume. The neck extends from the main body and has a second interior surface defining a hollow opening that is in fluid communication with the cavity. The fluoropolymer coating internally coats (e.g., seamlessly coats) the first interior surface and the second interior surface with a fluoropolymer layer.

The fluoropolymer layer can internally coat the entire interior surface of the chemical reagent bottle, including the interior of the neck of the bottle. In some embodiments, the fluoropolymer layer provides a smooth, seamless surface of substantially uniform thickness.

The main body and neck of the chemical reagent bottle can be glass. The glass can include fluorinated glass, borosilicate glass, or amber glass.

In some embodiments, the first interior surface and the second interior surface have a treatment to increase adhesion of the fluoropolymer to the glass. The treatment can include a binding layer between the first and second interior surfaces, collectively, and the layer of fluoropolymer. In some embodiments, the treatment includes increasing the surface roughness of the first and second interior surfaces.

In some embodiments, the fluoropolymer layer has a thickness of about 0.01 millimeters (mm) to about 5 mm. The fluoropolymer can be a polytetrafluoroethylene, a perfluoroalkoxy alkane, a perfluoroether, a copolymer of tetrafluoroethylene and perfluoroalkylvinylether, or a combination thereof.

The chemical reagent bottle can further include an exterior layer of a shatter-resistant material covering at least the first exterior surface of the main body. The shatter-resistant material can include a polyvinyl chloride. In some embodiments, the shatter-resistant material includes a fluoropolymer.

The chemical reagent bottles described herein can provide the chemical resistance of a fluoropolymer to the bottle, at a lower cost than a bottle made of a fluoropolymer. Further, the internally fluoropolymer coated surfaces of the bottle can prevent leaching associated with the type of glass selected for the bottle.

Also provided herein is a chemical reagent storage system including a chemical reagent bottle and a chemical reagent. The chemical reagent bottle includes a main body, a neck, and a fluoropolymer coating. The main body has a first interior surface defining a cavity for housing a chemical substance (e.g. a chemical reagent such as a solvent or an acid). The cavity has a preselected volume. The neck extends from the main body and has a second interior surface defining a hollow opening that is in fluid communication with the cavity. The fluoropolymer coating internally coats (e.g., seamlessly coats) the first interior surface and the second interior surface with a fluoropolymer layer.

The chemical reagent can be a solvent (e.g. an organic solvent), an acid, a base, or a combination thereof.

### BRIEF DESCRIPTION OF THE DRAWINGS

The claimed subject matter is described with reference to the accompanying drawings. A brief description of each figure is provided below. Elements with the same reference number in each figure indicated identical or functionally similar elements. Additionally, the left-most digit(s) of a reference number indicate the drawing in which the reference number first appears.

FIG. 1 is a front plan view of a chemical reagent bottle.

FIG. 2 is a longitudinal cross-section of one embodiment of the chemical reagent bottle of FIG. 1.

FIG. 3 is a longitudinal cross-section of a second embodiment of the chemical reagent bottle of FIG. 1.

FIG. 4 is a front perspective view of a 4 L amber glass chemical reagent bottle having a PTFE internal coating.

### DETAILED DESCRIPTION

The following detailed description will illustrate the general principles of the invention, examples of which are additionally illustrated in the accompanying drawings. In the drawings, like reference numbers indicate identical or functionally similar elements.

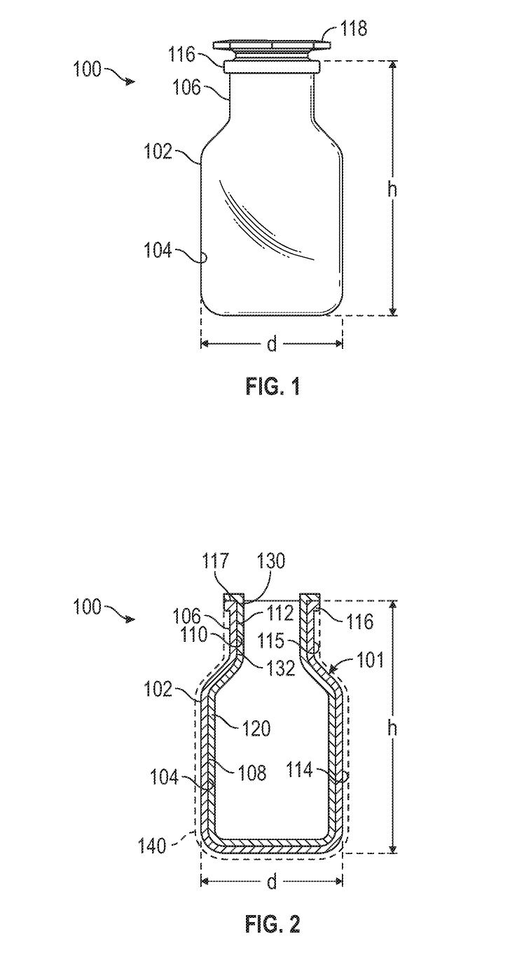

Referring to FIGS. 1-2, a chemical reagent bottle, generally designated by reference number 100, is shown that has a main body 102 having a first interior surface 104 defining a cavity 108 for housing a fluid (not shown). A neck 106 extends from the main body 102. The neck 106 has a second interior surface 110 defining a tubular opening 112 in fluid communication with the cavity 108 and the exterior environment. The tubular opening 112 of the neck 106 has an exterior end 130 and an interior end 132. The exterior end 130 may be closed by a removable closure, such as a stopper 118 or a cap (not shown). The neck 106 may include an exterior flange or lip 116, which may aid in the pourability of a fluid therefrom and/or the securability of a cap thereto. In one embodiment, as shown in FIG. 4, the neck 106′ includes threading on the exterior surface thereof for receipt of a threadable cap (not shown).

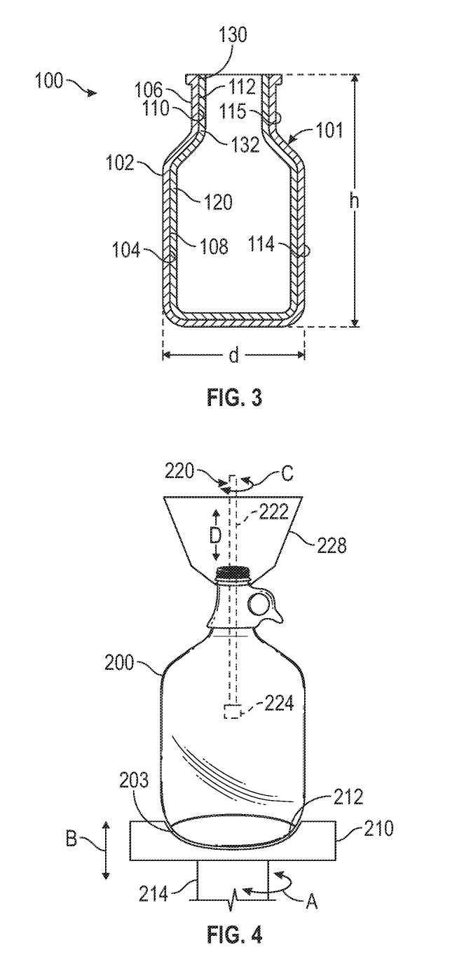

As seen in the cross-section of FIG. 2, from outside moving inward, the chemical reagent bottle 100 has a glass bottle 101, then a layer of a fluoropolymer 120 seamlessly coating the first interior surface 108 and the second interior surface 110. In this embodiment, the layer of fluoropolymer 120 continues onto the exterior, upper surface 117 of the lip 116 of the bottle 100. In some embodiments, the layer of fluoropolymer does not extend to the exterior, upper surface. For example, in the embodiment of FIG. 3, the layer of fluoropolymer 120 stops flush with the exterior end 130 of the tubular opening 112 defined by the neck 106 and does not extend on to the exterior upper surface 117.

The cavity 108 of the main body 102 has a preselected volume and the layer of fluoropolymer 120 reduces this preselected volume to define a reduced volume. The reduced volume of the cavity is about 4 L to about 50 mL, depending on the size of chemical regent bottle desired. Some other example bottle sizes include 100 mL, 250 mL, 500 mL, 1000 ml (1 liter), 2000 mL (2 liters), and 4000 mL (4 liters). While FIGS. 1-4 illustrate chemical reagent bottles typically for storing, dispensing liquids, or both the glass bottles may also be for storing and dispensing chemicals in a solid form, such as a powder, granules, pellets, etc.

Here, in all aspects, the main body 102 and neck 106 are made of glass. The glass may be, but is not limited to fluorinated glass, borosilicate glass, soda-lime glass, flint glass, amber (actinic) glass, aluminosilicate glass, phosphate glass, ceramic glass, and laminated glass. In some embodiments, a treatment to increase adhesion of the fluoropolymer onto the glass is applied.

In some embodiments, the treatment includes the application of a binding layer to the first and second interior surfaces before application of the fluoropolymer, thereby resulting in a binding layer between the first and second interior surfaces, collectively, and the layer of fluoropolymer. One example binding layer is an aqueous fluoropolymer coating disclosed in U.S. 2015/0079403, which is incorporated herein by reference in its entirety, that can be directly applied to glass with the need for any the treatment to the glass surface. The aqueous fluoropolymer binding layer can include at least one hydroxyfunctional fluoropolymer and at least one polyisocyanate, and, optionally, a polyol, a silane coupling agent, a coalescing agent, other additives, and combinations thereof.

In some embodiments, the treatment increases the surface roughness of the first and second interior surfaces 104, 110. Any such treatment may be preceded by a cleaning step, followed by a cleaning step, or both. An example treatment includes, but is not limited to, subjecting the glass to a blasting treatment with an abrasive to increases the roughness without reducing the integrity of the bottle. Silicon dioxide, such as quartz glass (in a composition that is at least 95% SiO₂ and has an average particle size in the range of about 70 μm-110 μm), is suitable for a blasting treatment to increase the surface roughness of the first and second interior surfaces 104, 110. In another example treatment, the first and second interior surfaces 104, 110 are etched with an etchant. The etchant can be an aqueous hydrofluoric acid (HF) solution. In some embodiments, the concentration of HF in the solution is about 5 wt. % to about 15 wt. %. in some embodiments, the etchant is a sodium hydroxide (NaOH) or potassium hydroxide (KOH) solution. In some embodiments, a blasting treatment and an etching treatment are implemented and either or both treatments may be preceded by a cleaning step, followed by a cleaning step, or both. Suitable surface cleaning steps include, but are not limited to, an acid rinse, a detergent solution rinse, a water rinse, a solvent rinse (cleaning and/or degreasing of the surface), and compressed air or other high pressure air source to blow away debris.

The layer of fluoropolymer 120 within the bottle can have a thickness sufficient to cover the interior surface without leaving gaps or openings of any size that leave the glass exposed to the chemical substance housed within the bottle. In some embodiments, the thickness is in the range of about 0.01 millimeter (mm) to about 5 mm or about 0.05 mm to 1 mm. For example, the thickness of the layer of fluoropolymer can be 0.15 mm. The fluoropolymer can be selected from the group consisting of a polytetrafluoroethylene (PTFE), a perfluoroalkoxy alkane, a perfluoroether, and combinations thereof. Some example PTFEs are sold under the brand name TEFLON® or TEFZEL® by The Chemours Company, such as a TEFLON® industrial PTFE coating. Other fluoropolymers are available under the HYFLON® brand by Solvay Specialty Polymers, Italy S.P.A., and the NEOFLON® brand by Daikin Industries, LTD.

In some embodiments, the layer of fluoropolymer includes a perfluoroalkoxy alkane. Examples of perfluoroalkoxy alkane include DUPONT's ® TeflonTM 532G-5010 and Teflon™ 532G-5011. In some embodiments, the perfluoroalkoxy alkane is Teflon™ 532G-5010.

In some embodiments, the layer of fluoropolymer includes a copolymer of tetrafluoroethylene and perfluoroalkylvinylether. For example, the layer of fluoropolymer can include a NEOFLON® PFA AC-series fluoropolymer, a NEOFLON® PFA ACX-series fluoropolymer, or a combination thereof

Further, an exterior layer of a shatter-resistant material 140 can cover at least the first exterior surface 114 of the main body 102. In some embodiments, the shatter-resistant material covers the second exterior surface 115 of the neck 106. The shatter-resistant material can include a polyvinyl chloride. In some embodiments, the shatter-resistant material includes a fluoropolymer, which may be any of the fluoropolymers disclosed above. When the exterior layer of shatter-resistant material 140 is present, any or a combination of the treatments discussed above for the interior surface may also be used to treat the exterior surface.

Referring now to FIG. 4, a support 210 is provided with an indentation 212 into which a bottle 200 is seated with its bottom 203 received therein. The support 210 is mounted to a shaft 214 that is rotatable in 360 degrees in a forward or a backward direction as noted by arrow A. The shaft 214 is also linearly translatable up and down, as noted by arrow B to move the bottle relative to a spray device 220. The spray device 220 includes an extension arm 222 terminating in a nozzle 224 defining a spray orifice (not shown). The extension arm 222 is connected to a source of fluoropolymer in a state that is sprayable through the spray orifice onto the first and second interior surfaces of the bottle 200. The extension arm 222 is rotatable in 360 degrees in a forward or a backward direction as noted by arrow C, as well as being linearly translatable up and down, as noted by arrow D. When spraying the fluoropolymer onto the first and second interior surfaces of the bottle 200, movement can be imparted to the support 212 and to the spray device 220 to move them relative to each other, meaning that there is simultaneous movement of the support 212 and the spray device 220. Alternately, just one of two may be used to impart rotation and linear translation effecting the spraying of the first and second interior surfaces of the bottle 200 with the fluoropolymer to for a substantially uniform (in thickness) layer of fluoropolymer.

In some embodiments, the movement of one or more of the support 212 and the spray device 220 is controlled varying the velocity as a function of the distance d between the spray orifice and the interior surface of the bottle 200 Alternately or in addition, the flow rate of the fluoropolymer through the spray device, and in particular as measured at the spray orifice, varies as a function of the distance between the spray orifice and interior surface of the bottle, especially in the neck of the bottle for the second interior surface. By controlling these parameters, the spray device 220 can be configured to deliver a uniform, seamless layer of a fluoropolymer.

As shown in cross-section in FIG. 4, a shield 228 is seated about the exterior surface of the neck of the bottle 200 to collect overspray of fluoropolymer. Since the entire second interior surface of the bottle needs to be coated with the fluoropolymer, the shaft 222, the support 210, or both are linearly translated to move the spray nozzle 224 into the neck while reducing the flow rate of the fluoropolymer.

Also provided herein is a chemical reagent storage system. The chemical reagent storage system includes a chemical reagent bottle and a chemical reagent located therein. The chemical reagent bottle includes a fluoropolymer internally coated over the entire interior surface thereof (e.g. seamlessly coated). The chemical reagent bottle can be any chemical reagent bottle described herein.

In some embodiments, the chemical reagent is a solvent, an acid, a base, or a combination thereof. The chemical reagent can also be a solvent mixture.

In some embodiments, the chemical reagent is an organic solvent. For example, the chemical reagent can include acetic anhydride, acetone, acetonitrile, benzene, benzonitrile, 2-butanone, butylacetate, tent-butyl methyl ether, carbon disulfide, carbon tetrachloride, chlorobenzene, 1-chlorobutane, chloroform, cyclohexane, cyclohexanone, cyclopentane, 1,2-dichlorobenzene, 1,2-dichloroethane, dichloromethane, di(ethylene glycol) diethyl ether, N,N-dimethylacetamide, N,N-dimethylformamide (DMF), 1,4-dioxane, ether, ethyl acetate, ethyl alcohol, ethylene glycol, ethylene glycol butyl ether, ethylene glycol dimethyl ether, heptane, hexane, hexanes, glycerol, 2-methoxyethanol, 2-methoxyethyl acetate, methyl alcohol, 2-methylbutane, 3-methyl-1-butanol, 4-methyl-2-pentanone, 2-methyl-1-propanol, 2-methyl-2-propanol, 1-methyl-2-pyrrolidinone, methyl sulfoxide, monoethanolamine, nitromethane, 1-octanol, pentane, 1-octanol, 1-propanol, 2-propanol, propylene carbonate, propylene glycol methyl ether acetate, pyridine, tetrachloroethylene, tetrahydrofuran, toluene, triethanolamine, 1,1,2-trichlorotrifluoroethane, 2,2,4-trimethylpentane, water, o-xylene, p-xylene, or a combination thereof.

In some embodiments, the chemical reagent is an acid. The acid can be an inorganic acid or an organic acid. For example, the acid can include an acetic acid, a hydrofluoric acid, a hydrochloric acid, a hydrobromic acid, a hydroiodic acid, a sulfuric acid, a sulfonic acid, a phosphoric acid, a phosphonic acid, a nitric acid, or a nitrous acid.

In some embodiments, the chemical reagent can be a solvent or solution for peptide or oligonucleotide synthesis. For example, the chemical reagent can be a 5-(benzylthio)-1H-tetrazole solution (e.g. 0.25 molar (M) in acetonitrile), N,N-Dimethylacetamide, a N-ethyldiisopropylamine solution (e.g. 2 M in 1-methyl-2-pyrrolidinone), a 4-methylpiperidine solution (e.g. 20 weight percent (wt. %) in DMF), a piperidine solution, or toluene.

In some embodiments, the chemical reagent is a standard, such as a solvent standard. The chemical reagent can also be a pharmaceutical intermediate.

The embodiments of this invention shown in the drawings and described above are exemplary of numerous embodiments that may be made within the scope of the appended claims. It is contemplated that numerous other configurations, especially shapes and cap/stopper attachment arrangements, of the chemical reagent bottle may be created taking advantage of the disclosed approach. In short, it is the applicant's intention that the scope of the patent issuing herefrom be limited only by the scope of the appended claims.

What is claimed is:

1. A chemical reagent bottle comprising:
a main body having a first interior surface defining a cavity for housing a chemical substance, the cavity having a preselected volume;
a neck extending from the main body, the neck having a second interior surface defining a hollow opening that is in fluid communication with the cavity; and
a fluoropolymer coating the first interior surface and the second interior surface with a layer of fluoropolymer.

2. The chemical reagent bottle of claim 1, wherein the main body and neck are glass.

3. The chemical reagent bottle of claim 2, wherein the glass comprises fluorinated glass, borosilicate glass, or amber glass.

4. The chemical reagent bottle of claim 2, wherein the first interior surface and the second interior surface have a treatment to increase adhesion of the fluoropolymer to the glass.

5. The chemical reagent bottle of claim 4, wherein the treatment comprises a binding layer between the first and second interior surfaces, collectively, and the layer of fluoropolymer.

6. The chemical reagent bottle of claim 4, wherein the treatment comprises increasing the surface roughness of the first and second interior surfaces.

7. The chemical reagent bottle of claim 1, wherein the layer of fluoropolymer has a thickness of about 0.01 mil to about 5 mil.

8. The chemical reagent bottle of claim 1, wherein the fluoropolymer is a polytetrafluoroethylene, a perfluoroalkoxy alkane, a perfluoroether, a copolymer of tetrafluoroethylene and perfluoroalkylvinylether, or a combination thereof

9. The chemical reagent bottle of claim 1, further comprising an exterior layer of a shatter-resistant material covering at least the first exterior surface of the main body.

10. The chemical reagent bottle of claim 9, wherein the shatter-resistant material comprises a polyvinyl chloride.

11. The chemical reagent bottle of claim 9, wherein the shatter-resistant material comprises a fluoropolymer.

12. A chemical reagent storage system comprising:
a chemical reagent bottle comprising
a main body having a first interior surface defining a cavity for housing a chemical substance, the cavity having a preselected volume,
a neck extending from the main body, the neck having a second interior surface defining a hollow opening that is in fluid communication with the cavity, and
a fluoropolymer coating the first interior surface and the second interior surface with a layer of fluoropolymer; and
a chemical reagent.

13. The chemical reagent storage system of claim 12, wherein the chemical reagent comprises one or more solvents.

14. The chemical reagent storage system of claim 12, wherein the chemical reagent comprises one or more acids.

15. The chemical reagent storage system of claim 12, wherein the chemical reagent comprises one or more bases.

16. The chemical reagent storage system of claim 12, wherein the main body and neck are glass.

17. The chemical reagent storage system of claim 16, wherein the glass comprises fluorinated glass, borosilicate glass, or amber glass.

18. The chemical reagent storage system of claim 12, wherein the first interior surface and the second interior surface have a treatment to increase adhesion of the fluoropolymer to the glass.

19. The chemical reagent storage system of claim 18, wherein the treatment comprises a binding layer between the first and second interior surfaces, collectively, and the layer of fluoropolymer.

20. The chemical reagent storage system of claim 18, wherein the treatment comprises increasing the surface roughness of the first and second interior surfaces.
